(19) United States
(12) Patent Application Publication
(10) Pub. No.: US 2012/0027503 A1
(43) Pub. Date: Feb. 2, 2012

(54) QUICK-RELEASE, LOOSE-LEAF MATERIALS CAPTURE MECHANISM AND ASSOCIATED METHODS

(76) Inventors: Ross Chiles, Taipei (TW); Tai-Yu Han, Taipei (TW); Katelyn Ryskamp, Spanish Fork, UT (US); David Meyers, Kaysville, UT (US)

(21) Appl. No.: 12/846,768

(22) Filed: Jul. 29, 2010

(51) Int. Cl. B42F 13/14; B42F 13/00

(52) U.S. Cl. 402/61; 402/80 R

(57) ABSTRACT

A quick-release capture mechanism for loose-leaf binders. Generally, the capture mechanism comprises binder posts and a retention clip that selectively and releasably attaches to a free end of the posts. The posts often comprise a tubular section and a post head with a recess defined between the two. In some cases, the retention clip is a rail having a plurality of elongated apertures that are configured to slidably and releasably engage with a plurality of posts, simultaneously. The apertures can have any suitable characteristic. For instance, the apertures can comprise a first width, a second width, and means for retaining a binder post within either the first or the second width. In such instances, while the first width is sized to allow the post head to be inserted perpendicularly therein, the second width is sized to receive the post's recess while preventing the head from passing perpendicularly therethrough.

### BACKGROUND OF THE INVENTION

1. Field of the Invention

The present invention relates to loose-leaf binders. In particular, the present invention relates to systems and methods for releasing and engaging a capture mechanism that is configured to retain loose-leaf materials within a loose-leaf binder.

2. Background and Related Art

Generally, a loose-leaf binder comprises an outer cover and a retention mechanism for holding pages of loose-leaf materials within the binder. The retention mechanism of a loose-leaf binder is configured to allow pages to be removed, added to, replaced, and returned to the binder without the pages being torn. This ability to selectively retain and release pages without damaging them makes loose-leaf binders ideal for applications in which the number and order of the pages within a binder may change during the binder's use. For instance, loose-leaf binders are often the preferred binding mechanism for photo albums, scrapbooks, journals, record books, and other applications in which pages are added to and removed from a binding mechanism.

Loose-leaf binders are currently available in several forms. Indeed, two common examples of loose-leaf binder types include ring and post loose-leaf binders. Generally, a ring loose-leaf binder, such as a 3-ring binder, has a plurality of rings that can be snapped open and closed in order to release pages from or to add to pages to the binder. Traditional ring binders have several shortcomings. For example, because the rings' size cannot be adjusted, the width of the binder's spine generally cannot be reduced for applications in which the binder contains only a few pages. Similarly, because the rings' size cannot be adjusted, the binder size cannot be increased for applications in which the number of pages exceeds the room provided on the binder's rings. In another example, the binder rings, particularly in larger dimensions, tend to become misaligned with use. As a result, over time the stored pages do not turn freely over the rings, and can occasionally become ripped from the misaligned rings. In still another example, where the pages exert a heavy load on the rings, the rings may open unintentionally and thereby allow the pages to fall from the binder.

With regards to post loose-leaf binders, such binders typically have a plurality of posts that are secured to a bottom surface of the binder's cover. These posts are designed to extend through aligned openings in the pages and in the top cover. At or near the top cover, the posts are generally captured by a releasable retention mechanism. The posts can come in a variety of fixed lengths with extender sections that can be screwed in to lengthen a post.

While post loose-leaf binders are free from many of the shortcomings associated with ring loose-leaf binders, post loose-leaf binders are not without their deficiencies. For example, some retention mechanisms used for post loose-leaf binders are difficult and cumbersome to use. For instance, some retention mechanisms require the use of a tool, such as a screwdriver to lock or release a screw that is used as the binder's retention mechanism. In other instances, certain retention mechanisms comprise a plurality of movable parts. Accordingly, such mechanisms can be costly to manufacture, relatively complicated to use, and can add additional thickness to the binder. In still other instances, certain retention mechanisms are configured to be locked to or released from each post in the binder, on an individual basis. Accordingly, the use of such retention mechanisms can be excessively time consuming and complicated.

Thus, while techniques and apparatus currently exist that are used to release pages from and to retain pages in a loose-leaf binder, challenges still exist, including those mentioned above. Accordingly, it would be an improvement in the art to augment or even replace current techniques and apparatus with other techniques and apparatus.

### SUMMARY OF THE INVENTION

The present invention relates to loose-leaf binders. In particular, the present invention relates to systems and methods for releasing and engaging a capture mechanism that is configured to retain loose-leaf materials within a loose-leaf binder.

Implementation of the present invention takes place in association with a post loose-leaf binder. Generally, the loose-leaf binder comprises one or more binder posts and a loose-leaf material retention clip for releasably securing pages within the binder.

Each binder post can comprise any suitable loose-leaf binder post. In some implementations, however, a binder post comprises a base member and a head member. Generally, the base member comprises a shaft having a threaded inner cavity and a footing, which has a diameter that is broader than the diameter of the shaft. Additionally, the head member generally comprises a threaded shaft that is configured to be received within the base member's threaded inner cavity. Opposite to its thread shaft, the head member comprises a free end having post head and a shoulder with a recess defined between the two. This free end of the head member is configured to selectively and releasably engage the retention clip to allow each post to releasably retain pages within the binder. In order to adjust the length of a post, one or more extension members having a threaded interior cavity and a threaded exterior shaft are optionally placed between the base member and the head member.

The retention clip can comprise any clipping mechanism that can selectively and releasably engage the recess in one or more posts by sliding into and out of the recess. Some examples of suitable retention clips comprise a loose-leaf material retention rail and a single-post retention clip.

Where the retention clip comprises a loose-leaf material retention rail, the rail can comprise any suitable component or characteristic that allows it to slidably engage or disengage from a plurality of posts, at the same time. Indeed, in some implementations, the rail defines a plurality of elongated apertures that comprise a first width and a second width. Generally, the first width is large enough to allow a post head to be inserted into the first width from the rail's back surface. In contrast, the second width is narrower than the first width. For instance, while the second width is wide enough to allow a post's recess to slide from the first width into the second width, the second width is narrower than the width of the post head. Accordingly, the post head can be inserted directly into the first width and the post's recess can be slid to the second width. Nevertheless, because the post head is wider than the second width, the rail cannot be lifted off the post head at the second width.

In order to selectively lock or release the rail from a plurality of posts simultaneously, the rail optionally comprises means for retaining a post into the first and/or second width of an elongated aperture. This retaining means can comprise any component or characteristic that allows the rail to function as intended. Some examples of suitable retaining means comprise one or more resilient arms, portions in the aperture that are narrower than the width of the post head, protuberances, or other objects that are configured to articulate against a portion of the post in a manner that increases the force required for the post to pass between the first width and the second width.

Where the retention clip comprises a single-post retention clip, the single-post clip may comprise any suitable component or characteristic that allows it to selectively and releasably lock onto the free end of a single post. In one example, the single-post retention clip defines an aperture having the first and the second width described above. While the single-post clip can comprise any suitable retaining means, in some implementations, the single-post clip comprises a portion of the aperture that is narrower than the width of the post's post head. In such implementations, this narrow portion is disposed at or between at least a portion of the first width and a portion of the second width. Accordingly, as the post passes between the first width and the second width, a portion of the post head's outer perimeter articulates against the narrow portion of the aperture. In this manner, the clip's movement is biased as the clip is forced to resiliently flex laterally to allow the post head to pass through the clip's narrow portion.

The retention clip (e.g., the single-post retention clip or the retention rail) can have any characteristic that allows it to resiliently flex laterally along the length of the aperture as the post passes between the first and the second width. For example, the retention clip can be made of a resilient material and/or the resilient clip can comprise a slit that extends from the aperture. Indeed, in some preferred implementations, the retention clip is made from a resilient material (e.g., nylon) and comprises a slit that extends from the second width of the aperture to an edge of the clip.

In addition to the aforementioned components and characteristics, the capture mechanism may comprise any other suitable component or characteristic. In one example, the retention clip comprises one or more gripping surfaces that are configured to help a user hold the retention clip when it is being locked to or released from one or more binder posts. In another example, the first and/or second widths of one or more apertures in the retention clip are recessed within the retention clip. As a result, a post head can be at least partially recessed within the retention clip when the clip is engaged with the post. In still another example, the retention clip comprises at least one concave surface that can be used for pushing the retention clip to cause one or more posts to pass between the first and the second width of one or more apertures.

While the apparatus and methods of the present invention have proven to be particularly useful in the area of scrapbooks and photo albums, those skilled in the art can appreciate that the described apparatus and methods can be used in a variety of different applications and in a variety of different areas. Indeed, the skilled artisan will recognize that the described apparatus and methods can be used for virtually any application in which a loose-leaf binder is used to retain pages of loose-leaf materials.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above-recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a perspective view of a representative embodiment of a loose-leaf materials capture mechanism;

FIGS. 2A and 2B each illustrate a perspective view of a different representative embodiment of a binder post;

FIGS. 3A and 3B each illustrate a top-plan view of a different representative embodiment of a loose-leaf material retention rail;

FIG. 4A illustrates a side-cutaway view of the retention rail of FIG. 3A cut along line A-A;

FIG. 4B illustrates a side-cutaway view of the retention rail of FIG. 3B cut along line B-B;

FIG. 5 illustrates a top plan view of a representative embodiment of a single-post retention clip; and

FIGS. 6A and 6B each illustrate perspective views depicting the use of a representative embodiment of the single-post retention clip.

### DETAILED DESCRIPTION OF THE INVENTION

The present invention relates to loose-leaf binders. In particular, the present invention relates to systems and methods for releasing and engaging a capture mechanism that retains loose-leaf materials within a loose-leaf binder.

In the disclosure and in the claims, the term “loose-leaf binder” and variations thereof shall refer to a mechanism that is configured to selectively receive, retain, and release loose-leaf materials without the materials being torn. It should be noted that while loose-leaf binders typically comprise a front and/or a back binder cover, such covers are not necessarily included in some embodiments of the described invention. Additionally, as used herein, the terms “loose-leaf pages,” “loose-leaf materials,” and variations thereof shall refer to any page, paper sheet, plastic sheet, protective sleeve, or other material that is capable of being bundled together with similar materials and being retained by the described loose-leaf materials capture mechanism.

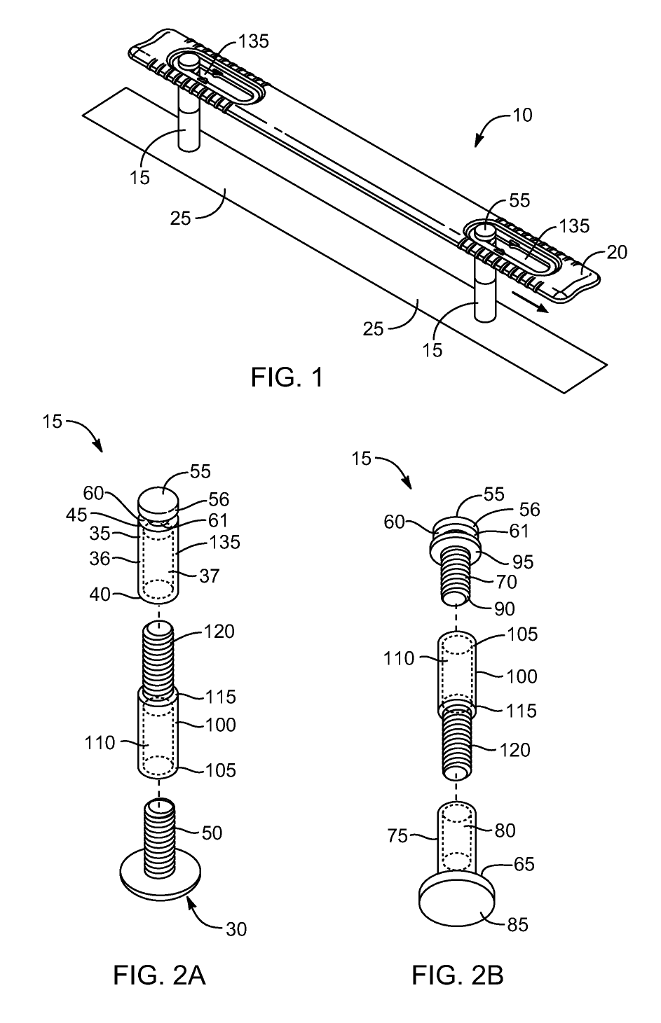

Embodiments of the present invention embrace a loose-leaf binder comprising a capture mechanism that is configured to quickly and easily release and/or retain loose-leaf materials. While the capture mechanism can comprise any suitable component that allows it to fulfill its intended purposes, FIG. 1 shows a representative embodiment in which the quick-release capture mechanism 10 comprises a plurality of binder posts 15 and a loose-leaf material retention clip (e.g., loose-leaf material retention rail 20). To provide a better understanding of the capture mechanism, each of its aforementioned components are described below in more detail.

Generally, the binder posts are secured to and extend from a surface of the loose-leaf binder (hereinafter “binding surface”). Accordingly, the posts can be inserted through holes in loose-leaf materials to retain the materials within the binder. While the posts can be secured to any suitable binding surface, including to a back binder cover, a front binder cover, a binder spine, a flap extending from an interior surface of a binder cover, or another suitable surface, FIG. 1 shows an embodiment in which the posts 15 are secured to a binding strip 25, which, in turn, can be attached to a binder cover (not shown) in any suitable manner.

The binder posts can comprise any suitable characteristic that allows them to be secured to a binding surface, to extend through aligned holes in loose-leaf materials, and to be selectively and releasably connected to a loose-leaf material retention clip. Two examples of suitable binder posts are illustrated in FIGS. 2A and 2B.

In the first example, FIG. 2A illustrates a representative embodiment in which the binder post 15 comprises a screw 30 and a tubular member 35. Where the binder post comprises a tubular member, the tubular member may comprise any suitable characteristic. For instance, FIG. 2A shows that the tubular member 35 comprises a proximal end 40 and a distal end 45. More specifically, FIG. 2A illustrates that the proximal end 40 of the tubular member 35 comprises an opening to a threaded inner cavity 37 (shown in dotted lines) that is configured to receive a threaded shaft 50 from the screw 30. Additionally, FIG. 2A shows that the distal end 45 of the tubular member 35 comprises a post head 55 and a recess 60 (collectively referred to as the “free end”).

In the second example, FIG. 2B shows a representative embodiment in which the binder post 15 comprises a base member 65 and a head member 70. While the various components of the binder post 15 can comprise any suitable component or characteristic, FIG. 2B shows an embodiment in which the base member 65 comprises a shaft 75 having a threaded inner cavity 80 (shown in dotted lines). FIG. 2B further shows that the base member 65 comprises a footing 85 that is wider than the base member's shaft 75. Additionally, FIG. 2B shows that the head member 70 comprises a post head 55, a recess 60, a threaded shaft 90, and a shoulder 95. While the shoulder can perform any suitable function, in some embodiments, the shoulder limits the extent to which the head member can be screwed into the base member. Accordingly, the shoulder can preserve the size of the recess when the head member is screwed into the base member.

No matter the type of binder posts implemented in the present invention, the posts' post head and recess can have any suitable characteristic that allows the loose-leaf material retention clip to be selectively locked to and released from one or more of the posts. In one example, the post head can be any suitable shape, including being substantially circular, elliptical, square, polygonyl, irregular, etc. Indeed, in some presently preferred embodiments, FIGS. 2A and 2B show that the post head 55 is substantially circular. In another example, the post head may be any suitable size that allows it to function as intended. For example, the post head can be any suitable size that allows the outer perimeter 56 or circumference (shown in FIGS. 2A and 2B) of the post head 55 to be larger than the outer perimeter 61 of the recess 60. In another example, the post head has a smaller diameter than the shoulder and/or tubular member. Accordingly, a loose-leaf material retention clip that is sized to barely fit over the post head can be prevented from sliding down the post.

The recess may comprise any suitable characteristic that allows it to have an outer perimeter that is smaller than the outer perimeter of the post head. In one example, FIGS. 2A and 2B show some embodiments in which the outer perimeter 56 of the post head 55 and the outer perimeter 36 of the tubular member 35 and base member's shaft 75 (respectively) are larger than the recess' outer perimeter 61.

The binder posts can be secured to the binder in any suitable manner. In one example in which the post comprises the screw and the tubular member, the screw's shaft is inserted through the binding surface (e.g., binding strip 25) and the shaft is screwed into the tubular member's inner cavity. In this example, the binding surface is pinched between the tubular member and the screw. In another example in which the post comprises the base member and the head member, the base member's shaft is inserted through the binding surface and the footing prevents the base member from passing distally and completely through the binding surface. In some embodiments, the footing is also secured to prevent the base member from being removed proximally from the binding surface. For instance, a backing surface can be placed behind the footing to prevent the footing from unintentionally being removed from the binding surface.

In some embodiments, the binder posts' height is adjustable. Indeed, the height of one or more posts can be adjusted in any suitable manner. In one example, a post's height is adjusted by tightening or loosening the screw from the tubular member or the base member from the head member. In another example, one or more extension members are added to or are removed from a binder post to increase or decrease the post's height, respectively. While an extension member may comprise any suitable component, FIGS. 2A and 2B show embodiments in which the extension member 100 comprises a first end 105 having an opening to a threaded interior cavity 110 (shown by dotted lines) and a second end 115 having an exterior threaded shaft 120. Accordingly, FIGS. 2A and 2B respectively show that one or more extension members 100 can be inserted between the screw 30 and tubular member 35 and between the base member 65 and the head member 70.

The described capture mechanism can comprise any suitable number of binder posts, including 1, 2, 3, 4, 5, 6, 7, or more. In some presently preferred embodiments, however, the capture mechanism comprises 2 or 3 posts.

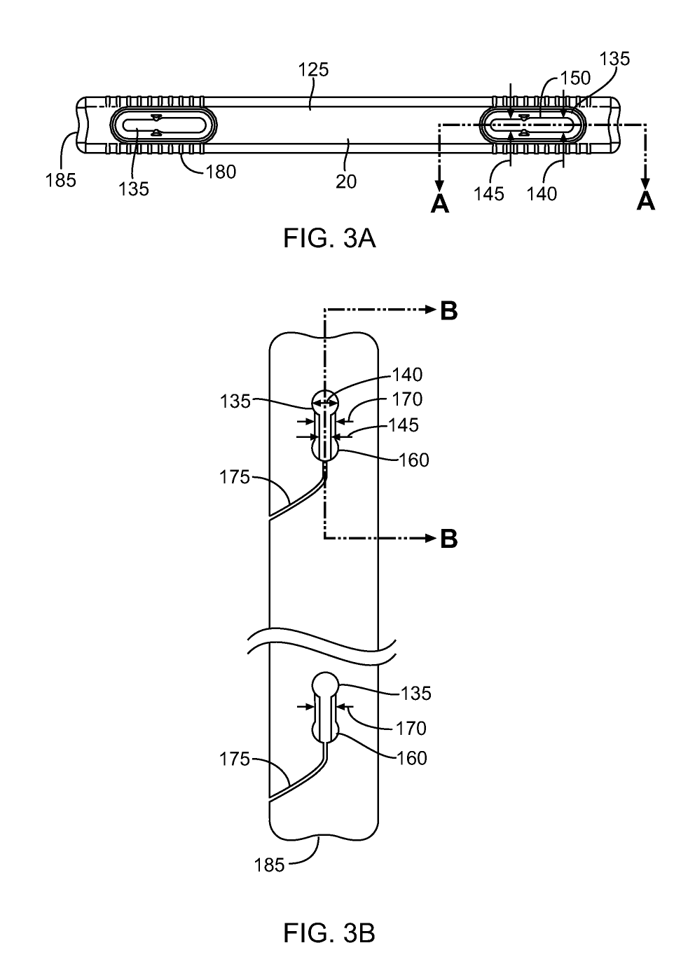

As previously stated, the capture mechanism also comprises a loose-leaf material retention clip. The retention clip is configured to selectively and releasably lock to the free end (e.g., post head 55 and/or recess 60) of at least one binder post in a manner that selectively locks and releases loose-leaf materials from the binder. The capture mechanism may comprise any suitable retention clip that is capable of sliding into the post's recess in a manner that allows the retention clip to selectively and releasably lock to the post. Some examples of suitable retention clips comprise a retention rail clip and a single-post retention clip.

Where the retention clip comprises a retention rail, the retention rail may have any suitable component or characteristic that allows it to be selectively and releasably locked to a plurality of binder posts. In one example, FIG. 3A illustrates a representative embodiment in which the retention rail 20 comprises an elongated piece of material having front surface 125 and a back surface 130 (not shown). Additionally, FIG. 3A shows that the rail 20 defines a plurality of elongated apertures 135.

While the rail can comprise any suitable number of apertures, in some preferred embodiments, the rail comprises one aperture for each binder post in the capture mechanism. In some instances, however, the rail comprises a number of apertures that is equal to, or greater than, the number of posts in the binder. In such instances, a single rail can be used with a variety of binders having a different numbers of binder posts. For instance, a rail having 3 apertures can be used as the retention rail in a binder with 2 or 3 posts, where the posts align with a corresponding aperture in the rail.

While the elongated apertures can be defined in any suitable location within the rail, in some embodiments, each of the apertures is defined in a position that corresponds to a post positioned in the binding surface. Accordingly, the plurality of apertures can slidably engage and disengage from a plurality of posts, simultaneously. By way of illustration, FIG. 1 shows that where the capture mechanism 10 comprises 2 posts 15, the rail 20 also comprises 2 elongated apertures 135 that are spaced to simultaneously mate with the posts 15.

The elongated apertures can comprise any suitable characteristic or component that allows the apertures to selectively and releasably lock the rail to a plurality of posts. FIG. 3A illustrates a representative embodiment in which the apertures 135 comprise a first width 140, a second width 145, and means for biasing and/or retaining (e.g., a resilient arm 150) the post (not shown in FIG. 3A) into the first width 140 or the second width 145. To provide a better understanding of the apertures, the first width, the second width, and the biasing and/or retaining means are each described below.

In some embodiments, the first width is sized and shaped to allow a post head to pass perpendicularly into and/or through the first width. As used herein, the term “pass perpendicularly into” and variations thereof, may refer to an object (e.g., the post head 55) being fully inserted into or withdrawn from an aperture through the back surface 130 of the rail, at any suitable angle.

The first width can be any suitable shape, including, but not limited to, a straight-channeled shape, a circular shape, a square shape, or any other suitable shape that allows the post head to be inserted perpendicularly thereto. By way of illustration, FIG. 3A illustrates an embodiment in which the first width 140 comprises a substantially straight channel having a curved (e.g., semicircular) end. Similarly, FIG. 3B illustrates a representative embodiment in which the first width 140 comprises a substantially circular shape.

In some embodiments, the second width is sized and shaped to allow the post's recess to be slid into the second width while preventing the post head from being fully inserted or removed from the second width, perpendicularly. In other words, the second width is wide enough to fit the recess but smaller than the width of the post head. Moreover, the channeled combination of the first and second widths is designed to accommodate a variety of posts having a range of spacing. Accordingly, the second width captures the post head and prevents the post head from being perpendicularly removed from the second width when the post (e.g., the recess) is slid (e.g., along the length of the aperture) into the second width from the first width.

The second width can have any suitable shape that allows it to function as intended. For example, the second width can have a substantially straight-channeled shape, a circular shape, a square shape, or any other suitable shape that allows the recess to fit within the second width while preventing post head from being fully inserted or removed perpendicularly from the second width. By way of illustration, FIGS. 3A and 3B illustrate embodiments in which the second width 145 has a substantially straight-channeled shape.

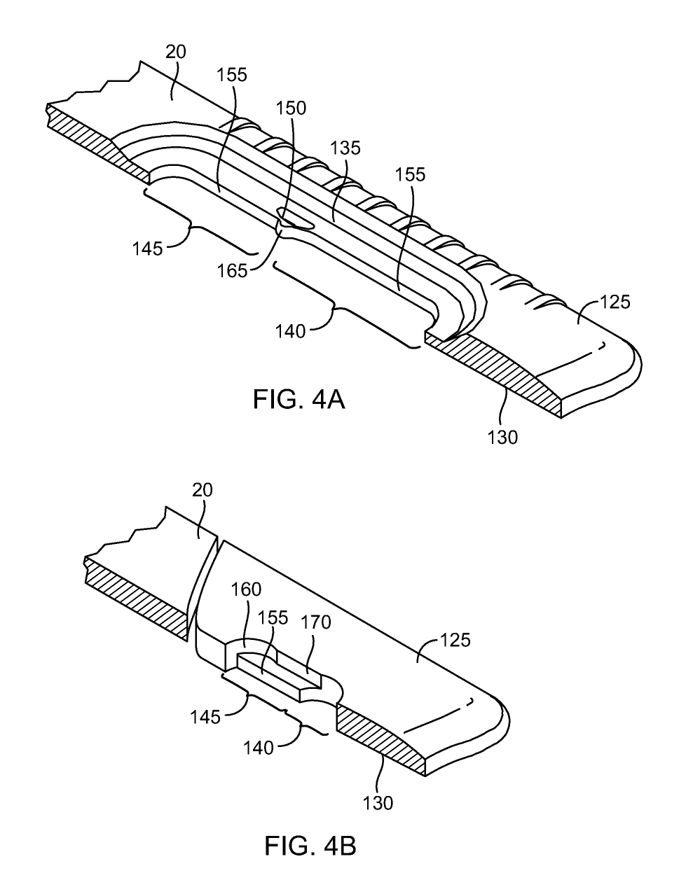

In some embodiments, the first width and/or the second width are defined by a collar that is recessed within the rail. As a result, when the rail is locked to the plurality of post heads, the post heads can be recessed, at least partially, within the rail. By way of illustration, FIG. 4A illustrates a side-cutaway view of the rail from FIG. 3A in which the rail 20 comprises a recessed collar 155 that defines the first width 140 and the second width 145. In particular, FIGS. 3A and 4A show an embodiment in which the recessed collar 155 defines the entire perimeter of the elongated aperture 135.

In another illustration, however, FIG. 4B illustrates a side cutaway view of the rail 20 from FIG. 3B in which the second width 145 is defined by the recessed collar 155 while the first width 140 lacks a recessed collar. FIG. 4B (and FIG. 3B) further shows that above the recessed collar 155, the rail 20 comprises a post head recess 160 that is sized and shaped to receive the post head (not shown in FIG. 3B or 4B) when the post's recess (not shown in FIG. 3B or 4B) is located in the second width 145.

As previously mentioned, one or more of the elongated apertures on the rail comprises means for retaining a binder post into the first width or the second width. This retaining means may comprise any component or characteristic that requires an increased force to allow the recess of the post to slide between the first and the second width. Some examples of suitable retaining means comprise one or more resilient arms, narrow portions of the aperture, protuberances, or other components capable of retaining the post into the first and/or the second width.

In one example, the retaining means comprises one or more resilient arms. In this example, the retaining means can comprise any suitable type of resilient arm, including an arm that articulates against the recess and/or the post head when the post passes between the first and the second width. By way of illustration, FIG. 3A shows a representative embodiment in which the retaining means comprises 2 resilient arms 150 that are disposed between a portion of the first 140 and a portion of the second 145 width. More specifically, FIG. 4A shows that the resilient arm 150 comprises a protuberance 165 that is configured to articulate against the post's recess (not shown) when the recess passes between the first 140 and the second 145 width. While FIGS. 3A and 4A show an embodiment in which both ends of the resilient arm 150 are connected to the rail 20, in other embodiments (not shown), the retaining means comprises a resilient arm having only one end attached to the rail.

In another example, FIGS. 3B and 4B shows that the retaining means comprises one or more narrow portions 170 of the elongated aperture 135 that are narrower than the width of the post head (not shown). Accordingly, as the post head is forced through the narrow portion of the aperture, the head's perimeter articulates against an inner surface of the narrow portion and causes the width of the narrow portion to resiliently expand laterally. Once the post head has moved past the narrow portion, the aperture relaxes so that the width of the narrow portion is allowed to decrease. In this manner, the narrow portion acts to bias the post head in either the first or the second width.

In still another example, the retaining means comprises a protuberance. While the protuberance may function in any suitable manner, in some embodiments, the protuberance causes the aperture to narrow between the first width and second width. Accordingly, the protuberance is forced to articulate against the post head and/or the post recess as the post passes between the first and the second width. While, in some embodiments, the protuberance resiliently flexes as the post passes between the first and the second width, in other embodiments, the rail along the length of the aperture resiliently flexes laterally as the post passes between the first and the second width.

Where the rail along the length of the aperture flexes laterally as the post passes between the first and the second width, the rail may flex in any suitable manner. In one example, the rail comprises a resiliently flexible material that allows the rail to resiliently flex as the post moves between the first and the second width. In another example, FIG. 3B shows an embodiment in which a slit 175 extends to from the aperture 135. While such a slit can extend from any suitable portion of the aperture, FIG. 3B illustrates an embodiment in which the slit 175 extends from the aperture's second width 145 to a side of the rail 20. Such a slit provides the rail with an additional amount flexibility to allow the rail to resiliently flex laterally along the length of the aperture as the post passes between the first and the second width.

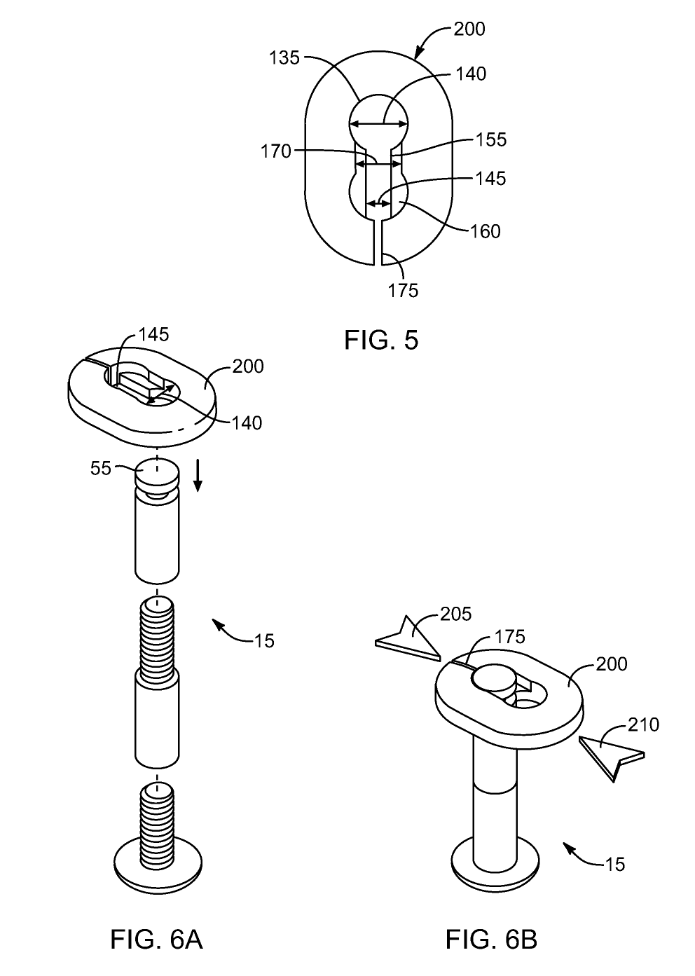

As previously mentioned, in some embodiments, the retention clip comprises a single-post retention clip. In such embodiments, the single-post retention clip may comprise any suitable component that allows it to selectively and releasably lock to the free end (e.g., the post head and/or recess) of a single binder post. In one example, the single-post retention clip comprises a single elongated aperture. In this example, the aperture can comprise any suitable component or characteristic, including those discussed above with respect to the rail's elongated apertures. By way of illustration, FIG. 5 shows a representative embodiment of a single-post retention clip 200 in which the single-post clip 200 comprises an elongated aperture 135 having a first width 140 and a second width 145. Additionally, FIG. 5 shows an embodiment in which the retaining means comprises a narrow portion 170 in the aperture 135 that is configured to articulate against a the outer perimeter (e.g., circumference) of the post head as the post (not shown in FIG. 5) passes between the first 140 and the second 145 width.

In addition to the aforementioned embodiments, the retention clip (e.g., rail 20 and single-post clip 200) can be modified or varied in any suitable manner. In one example, the retention clip comprises one or more surfaces that are configured to be gripped when the retention clip is locked or unlocked from the posts. While the retention clip may comprise any suitable gripping surface that is texturized to facilitate gripping the retention clip, some examples of suitable gripping surfaces comprise a surface comprising one or more protuberances, a roughened or knurled surface, a concave or convex surface, and any other surface that makes it easier to grip the retention clip. By way of illustration FIG. 3A illustrates an embodiment in which the gripping surface comprises a plurality of protuberances (e.g., ribs 180).

In another example, the retention clip (e.g., rail 20) is optionally modified to comprise one or more ends having a contact surface that is configured to be pushed so that the entire retention clip (e.g., rail 20) moves in the in the direction of the apertures length at the same time. While the contact surface may comprise any suitable surface, FIGS. 3A and 3B illustrate embodiments in which the contact surface comprises a concave surface 185 disposed at the ends of the rail 20.

The described capture mechanism can be used in any suitable manner. By way of example, a suitable method begins by securing the posts to a binding surface (e.g., a binder cover). Once the posts are secured to the binding surface, the posts are inserted through the aligned apertures in loose-leaf materials. Next, where the retention clip comprises the retention rail, the rail is set over the posts so that each post head extends into the first width of a corresponding aperture. With the post heads disposed in the first width, the user pushes the rail so that the post contacts the retaining means (e.g., resilient arms 150). When the force from the user is great enough to cause the retaining means to move past the post, the rail slides until the posts' recess is disposed in the apertures' second width.

In order to release the rail from the posts, the user simply slides the rail so that the posts' recesses are moved from the first width of each aperture back to first width of each aperture. With the recesses disposed in the first width, the rail can be lifted off the posts and the process can be repeated as desired.

It should be noted that where the retention clip comprises a single-post retention clip, the single-post retention clip can be used in a similar manner to the rail. However, instead of being selectively locked to and released from a plurality of binder posts simultaneously, as is the rail, each single-post retention clip is selectively locked to and released from a single binder post. By way of illustration, FIGS. 6A and 6B a representative method for using the single-post retention clip 200. Specifically, FIG. 6A shows that the single-post clip 200 is lowered on to a post 15 so that the post head 55 is inserted perpendicularly into the first width 140 of the aperture. Next, FIG. 6B shows that single-post clip 200 is forced in the direction of arrow 205 so that the post head 55 passes through and articulates against the narrow portion 170 of the aperture 135 and so that the post head 55 to becomes selectively captured by the second width (not shown in FIG. 6B). In order to release the clip from the post, the clip can simply be pushed in the direction of arrow 210. By so doing, the post head will be caused to slide from the second width back to the first width, where the clip can be lifted from the post.

The various components of the capture mechanism can be made of any suitable material. For example, in some embodiments, the posts are made of a metal (e.g., aluminum, steel, bronze, etc.), plastic (e.g., polyurethane), a ceramic, or any other suitable material. Indeed, in some preferred embodiments, the posts are made from aluminum or an aluminum alloy. In another example, the retention clip (e.g., rail 20) is made of a plastic (e.g., nylon, an acrylic, polyethylene, polyurethane, etc.), a metal (e.g., aluminum, bronze, etc.), or any other suitable material that allows the retaining means to bias a post into the first width or the second width. In some preferred embodiments, however, the retention clip (e.g., rail 20) comprises a resilient plastic, such as nylon.

The individual components of the capture mechanism can be made in any suitable manner. For example, the posts are molded, extruded, spun, tapped, died, cut, and/or otherwise shaped to perform their intended functions. In another example, the retention clip (e.g., retention rail 20) is extruded, molded, cut, and/or otherwise shaped to slidably and releasably engage one or more binder posts.

The described capture mechanism may offer several beneficial characteristics. In one example, where the retention clip comprises a retention rail, the rail can easily be locked to or be released from a plurality of posts, simultaneously. Accordingly, the rail can be used quickly and easily—without requiring a retention clip to be individually placed on or removed from each post in the binder. Indeed, once the posts' recesses are placed in the first width of corresponding apertures, the rail can be locked to each of the posts in a single movement.

In another example, because the rail can comprise a single piece of material, the rail does not require that additional pieces (e.g., locking mechanisms) be manipulated in order to lock or release the rail from posts. Accordingly, the retention clip can be easy to use and inexpensive to manufacture.

The present invention may be embodied in other specific forms without departing from its spirit or essential characteristics. The described embodiments and examples are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A loose-leaf material retention rail, comprising:
a rail having more than one elongated aperture that defines:
a first width sized to allow a post head on a binder post to pass perpendicularly into the first width; and
a second width sized to capture the post head while preventing the post head from passing perpendicularly into the second width; and
means for retaining the binder post in a position selected from the first width and the second width.

2. The retention rail of claim 1, wherein the second width is defined by a collar that is recessed within the rail.

3. The retention rail of claim 1, wherein the first width and the second width are defined by a collar that is recessed within the rail.

4. The retention rail of claim 1, wherein the retaining means comprises a narrow portion of the aperture that has a width being smaller than a diameter of the post head, wherein the narrow portion is configured to articulate against a perimeter of the post head.

5. The retention rail of claim 1, wherein the retaining means comprises a resiliently flexible arm.

6. The retention rail of claim 5, wherein the resiliently flexible arm further comprises a protuberance that is configured to articulate against a perimeter of a recess defined in the binder post.

7. The retention rail of claim 1, wherein the rail comprises a slit that extends from the aperture to allow the rail to resiliently flex laterally along a length of the aperture.

8. The retention rail of claim 1, further comprising a texturized surface for gripping the rail.

9. A loose-leaf materials capture mechanism, comprising:
a plurality of binder posts secured to binding surface; and
a rail defining more than one elongated aperture that defines:
a first width sized to allow a post head on the binder post to pass perpendicularly into the first width; and
a second width sized to capture the post head while preventing the post head from passing perpendicularly into the second width,
wherein the rail further comprises means for retaining the binder post in a position selected from the first width and the second width.

10. The capture mechanism of claim 9, wherein at least one of the plurality of binder posts comprises:
a base member having a threaded inner cavity; and
a head member comprises a threaded shaft.

11. The capture mechanism of claim 10, wherein the head member comprises a shoulder and the post head with a recess defined between the shoulder and the post head.

12. The capture mechanism of claim 9, wherein the second width is defined by a collar that is recessed within the rail.

13. The capture mechanism of claim 9, wherein the first width and the second width are defined by a collar that is recessed within the rail.

14. The capture mechanism of claim 9, wherein the retaining means comprises a narrow portion of the aperture that has a width being smaller than a diameter of the post head, wherein the narrow portion is configured to articulate against a perimeter of the post head.

15. The capture mechanism of claim 9, wherein the retaining means comprises a resiliently flexible arm.

16. A loose-leaf material retention clip, comprising:
a clip defining an aperture having:
a first width sized to allow a post head on a binder post to be inserted perpendicularly into the first width;
a second width sized to allow a recess defined in the binder post to slide into the second width while preventing the post head from being inserted perpendicularly into the second width; and
a narrow portion disposed between at least a portion of the first width and at least a portion of the second width, wherein the narrow portion has a width that is smaller than a diameter of the post head, and wherein the narrow portion is configured to articulate against a perimeter of the post head.

17. The retention clip of claim 16, wherein the second width is defined by a collar that is recessed within the rail.

18. The retention clip of claim 16, wherein the clip further defines a post head recess that is sized and shaped to receive the post head.

19. The retention clip of claim 16, wherein the clip further defines a slit that extends from the aperture.

20. The retention clip of claim 19, wherein the slit extends from the second width of the aperture.
